(19) United States
(12) Patent Application Publication
(10) Pub. No.: US 2009/0094653 A1
(43) Pub. Date: Apr. 9, 2009

(54) METHOD AND SYSTEM FOR SIMULTANEOUS CONFERENCING AND INTERACTIVE DISPLAY AND CONTROL OF VIDEO OVER A DISTRIBUTED NETWORK

(75) Inventor: Steven C. SHIELDS, Newport Beach, CA (US)

Correspondence Address: MORRISON & FOERSTER LLP, 1650 TYSONS BOULEVARD, SUITE 400, MCLEAN, VA, 22102, US

(73) Assignee: ICoach, Inc, Newport Beach, CA (US)

(21) Appl. No.: 12/130,853

(22) Filed: May 30, 2008

Related U.S. Application Data
(60) Provisional application No. 60/960,643, filed on Oct. 9, 2007.

(51) Int. Cl. H04N 7/173

(52) U.S. Cl. 725/109

(57) ABSTRACT

A video is played simultaneously at different nodes of a distributed network. The simultaneous playing is controlled through an intermediary server, which receives playback instructions from one or more of the different nodes and then sends simultaneous playback commands each of the different nodes in response to the playback instructions. The different nodes then play the video in accordance with the playback commands.

### CROSS-REFERENCE TO RELATED APPLICATION

This application claims the benefit of U.S. Provisional Application, Ser. No. 60/960,643, filed Oct. 9, 2007.

### FIELD OF THE INVENTION

The present invention relates to conferencing over a distributed network. More particularly, the present invention relates to the interactive and simultaneous display and control of pre-recorded video data at two or more nodes in a distributed network.

### BACKGROUND

Real time videoconferencing over a distributed network is known, in which live video is transmitted between two or more nodes on a distributed network. Moreover, simultaneous transmission of pre-recorded video to two or more nodes on a distributed network is also known. However, the loading of pre-recorded video data at one node, and the interactive and simultaneous viewing and viewing control of the pre-recorded video data at two or more nodes on a distributed network has not been accomplished.

### BRIEF DESCRIPTION OF THE INVENTION

The present invention provides a method and system for real-time interactive communication over the internet which includes the simultaneous viewing and control of pre-recorded video content. The system includes a media download manager that silently downloads videos required for the communication session to the local computer of each participant before the session so that all participants can view videos simultaneously and efficiently. The system also preferably includes a voice communication and/or messaging system that enables the smooth communication and interaction between participants. The system also includes playback manager software that controls the playback of the video. The system preferably may include video manipulating tools that facilitate and enhance the simultaneous video viewing session. The system and method is very scalable since it greatly relieves the requirement for the server and bandwidth by distributing these requirements to participants' local computers. The system also permits the recording of sessions and the storing of recorded sessions for later playback.

### DETAILED DESCRIPTION OF THE INVENTION

According to a preferred embodiment of the invention, a first user loads a pre-recorded video file on to a node on a distributed network. Alternatively, the node itself may include hardware and software capable of capturing video data directly. The user then uploads the video file to an intermediary server over a distributed network. According to a preferred embodiment, the system may automatically convert all uploaded videos into WMV format. In addition, the first user contacts a second user at a second node on the distributed network, preferably by electronic communication via the intermediary server, to advise the second user that a video file has been uploaded to the intermediary server and invites the second user to a simultaneous viewing of the uploaded video file. If the second user wishes to accept the invitation of the first user, the second user may advise the first user, via the intermediary server, of a date and time for the simultaneous viewing of the uploaded video file.

The intermediary server maintains a record of the scheduled date and time for the simultaneous viewing of the uploaded video file and may optionally send periodic electronic reminders to the first and second users. Before the scheduled date and time for the simultaneous viewing of the uploaded video file, the intermediary server downloads to the second node, and preferably to the first node as well, a copy of the uploaded video file. The respective downloaded copies of the uploaded video file are accessible by a client agent resident on said first and second nodes, which client agent is in electronic communication with playback manager software on said intermediary server.

At or before the scheduled date and time, the first and second users each establish communication with the intermediary server and the intermediary server initiates the communication session between said first and second nodes via said intermediary server. Voice communication may also be established between said first and second nodes using VOIP protocols or other known methods. Alternatively, the first and second users may establish separate voice communication over a separate network, for example land-based and/or wireless telephone networks. In addition, or alternatively, the first and second users may establish a line of communication via instant message (IM) protocol, either through an IM service provided by or through said intermediary server, or through a separate IM service operating between said first and second notes in parallel with said connection established through the intermediary server.

When the communication session between said first and second nodes is established, an opening session screen is displayed on said first and second nodes. Said opening session screen preferably will include a frame display of the selected and pre-downloaded video file. The display also preferably includes roll-over playback control “buttons” and sliders for simultaneous viewing and control of the video-file. Either one or the other of said first and second users may use the playback control buttons to play, pause, frame advance, slide forward or back, fast forward or rewind the downloaded video file. The playback manager constantly and in real-time monitors all playback instructions executed at each node connected in a communication session. All playback instructions executed by a user at one node are instantly registered by the playback manager at the intermediary server and simultaneously transmitted by the playback manager to the other node, thereby causing the identical playback command to be executed on the video playback occurring at both said first and second nodes. According to one embodiment, the system may permit a first user to “lock” or “unlock” the playback controls of other users so as to maintain playback control. Alternatively, the system may be configured so that only one user can execute playback controls.

When more than two nodes/users are connected via said intermediary server in a single communication session, the same steps apply. All playback instructions executed by a user at one node are instantly registered by the playback manager at the intermediary server and simultaneously transmitted to the playback mangers at every participating node, thereby causing the identical playback command to be executed on the video playback occurring at each participating node.

In this fashion, simultaneous and real time playback and control of pre-recorded video data can be accomplished between two or nodes on a distributed network. As discussed above, simultaneous text and/or voice communication may occur between participating nodes over the same communication session, or in parallel via a separate network connection.

The system of the invention may also be configured to record video viewing sessions and store the recorded sessions either for use in a subsequent joint session or for later independent viewing by a session participant.

According to a more preferred embodiment of the invention, the playback manager and corresponding client agents may provide additional interactive “markup” tools for enhancing the value of the simultaneous video playback. The interactive markup tools may include standard markup or “paint” tools such as dot, line, arrow, polygon, shaded polygon (“fill”), circle (“open dot”), highlighting, free hand drawing, and text box, including any of the foregoing in a variety of colors, thicknesses and fonts. These tools may be accessible to the user at any node via drop down menu during the communication session. As with the standard video playback commands (i.e., play, pause, frame advance, fast forward, and rewind), any interactive markup tool commands executed at one node are instantly registered by the playback manager software at the intermediary server and instantly transmitted to every other participating node so that whatever markups are being made over the video playback at one node are being simultaneously reproduced in real time at every other participating node.

According to yet another preferred embodiment of the invention, two or more copies of a video file may be simultaneously displayed at participating nodes, synchronously or asynchronously, side by side, partially overlaid or fully overlaid. The value of this variety of multiple copy playback options will become more clear through the more specific examples described below. The playback of each video file may be separately controlled by a set of playback control buttons for each copy of the video file being displayed.

According to a further preferred embodiment of the invention, two or more different video files may be simultaneously displayed at participating nodes, synchronously or asynchronously, side by side, partially overlaid or fully overlaid. As with the playback of multiple copies of a single video file, the playback of each different video file may be separately controlled by a set of playback control buttons for each different video file being displayed.

The video playback controls may also include a luminance intensity/transparency slide to control the relative luminance intensity/transparency of a displayed video file. This is particularly useful when the partial or full video overlay feature is employed.

The basic technical features and embodiments of the present invention having been described, they will now be described in the context of a further embodiment of the invention, a web-based interactive teaching/coaching environment and tool.

According to this embodiment, a host server acts as the intermediary server and also supports a public website for access to and use of the interactive teaching environment and tool. The public website may include a main page which serves as a portal to the website and which provides advertising and introductory instructions for the interactive teaching environment and tool, as well as a logon id and password-based sign-in for registered members of the website, and a link to a new member registration page. Registered members preferably include teachers/coaches and students. The main page may include a list of registered coaches and teachers (hereinafter “instructors”).

According to this embodiment, registered member instructors may be offered hosted templated but customizable web pages on said host server where said instructors may post their experience and qualifications, team information, class and/or practice schedules, etc. Hosted instructor web pages may optionally be made available over the internet to non-registered members for informational and advertising purposes. These hosted instructor web pages may be accessible by clicking on the name of the instructor in the main page list of registered instructors.

According to another aspect of this embodiment member students may also establish a homepage on the host server. However, it is more preferred that student homepages are not accessible to persons other than the student and are merely maintained on the host server as a user friendly interface for the student to store and manage uploaded video files and to interact with the system, including making/requesting appointments with instructors for simultaneous video teaching or coaching sessions.

According to the invention, a student has or creates a video of him or herself engaging in the activity for which the student would like instruction and loads the video file onto his or her home computer. The student, having previously registered with the system of the invention, accesses the internet and logs onto the host server and onto his or her homepage. Following instructions accessible through the main page or on his or her personal homepage, the student uploads the video file onto the host server. The host server then sends a message to the student asking whether the student would like to request an instructional session with a registered instructor. If the student wishes to request an instructional session, the student may select the name of a registered instructor from a drop down menu. Alternatively, the student may select from a list of saved instructors on his or her student home page. As another option, the student may log onto the hosted home page of a registered instructor and enter a request for an instructional session.

When a student indicates to the system a desire to request an instructional session, the system optionally may prompt the student to identify one or more saved video files for possible use during the requested instructional session. The system may also ask the student whether the session is to be recorded and saved for later viewing. The system may also ask the student whether video play back controls are to be shared by both student and instructor or used by student only or by instructor only.

Whatever the method by which the system receives a student's request for an instructional session, the request is transmitted to the selected instructor by e-mail, by message posted on the instructor's hosted home page, or by any other known messaging system. The transmitted request for instructional session may optionally include, as an attachment or embedded file, all or a portion of one or more video files proposed for use during the requested instructional session. When the instructor receives the request for instructional session, the instructor may accept, conditionally accept, decline or ignore the request. If the instructor wishes to accept the request for instructional session, he or she may select a proposed date and time for the instructional session from drop down menus or calendar functions supported by the host server. Preferably, the host server will also prompt the instructor to select one or more video files of the requesting student for use during the instructional session. The host server may also provide the instructor with the option of selecting additional video files for the instructional session from a library of archive video files. The library of archive video files may be maintained on the instructor's personal computer, on the host server, or a combination of both. The server may also indicate if the student has requested that the session be recorded and offer the instructor the option to veto the request. The server may also indicate the student's selected video play back control option and offer the instructor the option to veto or change the selected option.

The host server then transmits the proposed date and time for the instructional session to the requesting student. The requesting student may accept or decline the proposed date and time for the instructional session, or propose an alternative date and time. Once a proposed date and time for the requested instructional session have been accepted by both instructor and student, the host server saves the scheduled date and time in memory. The host server also maintains a record of the video files selected for use during the instructional session. Optionally, the host server may transmit periodic reminders to the instructor and student of the scheduled date and time for the instructional session.

At or before the date and time for the scheduled instructional session, the host server queues the selected video files for downloading to the home computers of the student and instructor. When the student and instructor access the host server and logon to the system, the host server transmits messages to both student and instructor asking if they wish to begin the instructional session and optionally requesting permission to download the video files selected for the instructional session. Optionally, the student and/or instructor may decline the downloading of selected video files and indicate that copies of the selected video files are already resident on their home computers. If the student and/or instructor indicate that a copy of one or more video files are already resident on their home computers, the host server may request permission to scan the memory of the student or instructor home computer to verify the existence of the selected video file and to confirm that it is an identical copy.

If the student and instructor both indicate their intention to begin the scheduled instructional session, the host server then downloads the selected video files onto the student and instructor home computers. According to an alternative embodiment, the host server may send a message to student and instructor prior the scheduled instructional session requesting that they logon to the host server for the purpose of downloading the selected video files. According to this alternative embodiment, instructional time is not wasted while the instructor and student wait for the download of multiple video files.

Once the student and instructor have confirmed their desire to begin the scheduled instructional session, and the selected video files have been downloaded or confirmed as having identical copies on the home computers of the student and instructor, the host server opens the instructional session, effectively linking the home computers of the instructor and student via the host server. According to one embodiment of the invention, the instructor and student are displayed identical screens, with identical video play back controls and markup tools, etc. According to another embodiment of the invention, the host server provides a “student” interface screen to the student's home computer and an “instructor” interface screen to the instructor's home computer. According to this embodiment the instructor may optionally be provided with more video playback and markup tool options than are provided to the student interface.

According to a preferred embodiment of the invention, when the instructional session is opened between the student and instructor computers, voice communication is also established between the student and instructor computers using VOIP protocols. Integration of voice communication into the instructional session through the host server is most preferred as it ensures that video and voice communication are fully synchronized and does not require a separate communication network.

According to another embodiment, voice communication may be established between the student and instructor over a separate network, for example land based and/or wireless telephone networks. Alternatively, or in addition to voice communication, an instant message session may be established between the student and instructor computers. The instant message session may be hosted by the host server, or it may be separately established between the student and instructor computers over the internet.

The instructional session having been opened, and voice and/or text communication established between the student and the instructor, the instructor and student may conduct the session according to their preferences and goals. Most preferably, the simultaneous playback and control of the selected video files at both the student and instructor computers plays a central role in the instructional session. According to this embodiment, the instructor may select a video file for playback from a pull down file list or icon set. When a video file is selected for playback, the playback manager on the host server sends an instruction to the client agents resident on the instructor and student computers to queue the copy of the selected video file resident on the instructor and student computers for play back. The instructor may then use the video playback buttons to control the play back of the selected video file. The playback manager software on the host server monitors the instructor's use of the play back controls. When the instructor activates a control button, the playback manager instantly registers the instruction and simultaneously sends an instruction to the client agents on both the instructor's computer and the student's computer to execute the command corresponding to the control button activated by the instructor. In this fashion, the video files resident on both instructor and student computers respond immediately and simultaneously to the commands executed by the instructor. As the instructor and student are preferably in voice communication, the instructional session may proceed seamlessly and without interruption, with the simultaneous video play back acting as the central instructional aid.

As discussed above, the instructor's use of the video play back may be further enhanced by the use of mark-up tools provided by the host server during the instructional session. As the video is in play back mode under the instructor's control, the instructor may select one or more of a variety of mark-up tools from a pull down menu to highlight, or otherwise annotate the video playback. Just as the playback manager on the host server monitors the instructor's execution of playback commands and simultaneously instructs the client agents on the instructor and student computers to carry out the corresponding function, the playback manager monitors the instructor's selection and use of the mark-up tools and instructs the client agents on both the instructor and student computers to reflect the markups and/or annotations on the video playback.

According to a more preferred embodiment, the instructor may identify two or more video files, or multiple copies of the same video file, for simultaneous playback, either synchronously or asynchronously. In the case of the multiple video file playback, a set of playback control buttons is displayed for each video file selected for play back. For example, the instructor may choose one video file showing the student rehearsing or practicing a skill that is the subject of the instructional session. The instructor may then choose a second video file showing the student rehearsing or practicing the same skill, but at an earlier stage in development. Alternatively, the second video file may show the instructor or other person showing the correct form of the skill. As used herein, “simultaneous synchronous playback” means that two or more video files (or two or more copies of the same video file) are played back at the same time, with the action in the video synchronized, i.e., same action at the same time—for example, showing a golf swing at the same stage at the same time. As used herein, “simultaneous asynchronous playback” means that two or more video files (or two or more copies of the same video file) are played back at the same time, with the action in the videos delayed in time or advanced in time relative to one-another, for example showing a golf swing at different stages, but at the same time. In this way, simultaneous synchronous or asynchronous playback of the two or more video files may significantly enhance the value and power of the instructional session.

According to this embodiment, the instructor may have the option of moving the relative positions of the two or more video playbacks so that they overlap partially or completely. According to a further embodiment of the invention, the instructor may control the relative luminance of the overlayed video files being played back to highlight one or the other of the video files. In this fashion, the instructor can use the video playback tool to even more dramatically show the differences between the skill demonstrated in one video file and the same skill demonstrated in a second video file. As with the playback of a single video file, the play back manager on the host server monitors the instructor's commands and instantly instructs the client agents on the instructor and student computers to execute the corresponding function for any one or more of the multiple video files being played back.

According to a further embodiment of the invention, the instructor may interact with two or more students, each at different student computers, in a single instructional session. According to this embodiment, for example, a team coach may have an interactive coaching session with multiple members of his team, each team member attending the interactive instructional session from his own home computer. According to this embodiment, the selected video files may include game videos or practice videos showing interaction between players of the same team and/or between players of different teams. Similarly, such instructional team sessions may be hosted by two or more coaches, each at their own home computer. In such an environment, the host server may provide head coaching controls and mark-up tools to one coach, and assistant coach video controls and mark-ups to other coaches. According to a further aspect of this invention, when a head coach is operating the video controls or mark-up tools, the student interfaces can reflect that the video playback and mark-up tools is under the direction of the head coach. Similarly, when an assistant coach is operating the video control playback controls or the mark-ups, the student and coach interfaces can reflect that the video playback and mark-up tools is under the direction of the assistant coach.

According to this team instructional environment, all or some of the members of the team may be in simultaneous voice communication with the coaching staff through VOIP protocols via the host server and or through other networks such as landbased and/or wireless telephone networks. Similarly, all participants of a team coaching session may interact using text in an instant message environment hosted either by the host server or in parallel with the instructional session through an independent server.

Once the session is completed, whether between two or more participants, any requested recordings of the session are made available to the requester, either on the host server or downloaded to the requestor's computer. At the option of the requestor, the recording may be made available to other session participants, as well.

According to a further embodiment of the invention, the host server management of video playback can occur through independent instructor websites, as an alternative to instructor homepages hosted by the host server. According to this embodiment, a student can log onto an independent instructor's homepage and request a video instructional session. If the coach accepts the request for instructional session, a message is sent to the host server requesting video playback management services. Such services can be provided on a subscription basis, a one-time fee basis, or other prearranged or on-demand payment basis. According to this embodiment, the interaction between the host server playback manager and the participant computers is the same as described above. In brief, at or before the time of the scheduled instructional session, the host server downloads to the instructor computer and the student computer a copy of the video files selected for use during the instructional session, or verifies that the selected videos are already resident on the instructor or student computers. During the instructional session, the host server maintains constant communication with the student and instructor computers, monitoring the use of video control buttons and mark-up tools, and instantly transmitting registered instructions to each computer participating in the instructional session.

As described above, the invention is not limited to use by instructors and students. As another example, a group of peers may use this invention to simultaneously view and discuss any kind of pre-recorded video data, including movies, television shows, etc. This invention can be applied to any situation in which simultaneous viewing of video is desired at multiple nodes on a distributed network.

The foregoing description has been made with respect to specific embodiments for illustrative purposes only.

We claim:

1. A method for managing the simultaneous viewing of a video on two or more nodes of a distributed network, wherein a copy of the video is stored at each of the two or more nodes, the method comprising:
receiving at an intermediary server a playback instruction from one of the two or more nodes; and
in response to receiving the playback instruction, transmitting from the intermediary server a corresponding playback command to each of the two or more nodes to control the simultaneous display of a portion of the video at each of the two or more nodes.

2. The method of claim 1, wherein the playback instruction comprises an instruction selected from the group consisting of a play instruction, a pause instruction, a frame advance instruction, a rewind instruction, and a fast forward instruction.

3. The method of claim 1, further comprising:
during the simultaneous display of the portion of the video, managing voice communication between two or more users associated with the respective two or more nodes.

4. The method of claim 1, further comprising:
receiving a markup instruction from one of the two or more nodes; and
in response to receiving the markup instruction, transmitting a corresponding markup command to each of the two or more nodes, wherein the markup command causes a graphic to be superimposed over the video displayed at each of the two or more nodes.

5. The method of claim 4, wherein the graphic is selected from a group consisting of a dot, a line, an arrow, a polygon, and a circle.

6. The method of claim 1, further comprising:
recording the video display as shown in real-time at each of the two or more nodes.

7. The method of claim 1, wherein one or more of the two or more nodes includes a graphical user interface including graphical input components for allowing a user to generate the playback instructions.

8. The method of claim 1, wherein the video is displayed at each of the two or more nodes through a remotely hosted web portal.

9. A system for controlling the simultaneous display of a video on two or more nodes of a distributed network, wherein a copy of the video is stored on each of the two or more nodes, the system comprising:
a intermediary server configured to receive playback instructions from one or more of the two or more nodes and to transmit one or more control signals to each of the nodes to control simultaneously playback of the downloaded video at the two or more nodes.

10. The system of claim 9, wherein the intermediary server comprises a communication component adapted to manage communication between two or more users associated with the respective two or more client nodes.

11. The system of claim 9, wherein the intermediary server further comprises a web hosting component configured to generate data for a graphical user input portal to be displayed on a screen at one or more of the two or more nodes, wherein the portal receives user inputs for requesting participation in the simultaneous video display, displays video during the video display, and receives user inputs corresponding to the playback instructions.

12. The system of claim 9, wherein each of the two or more nodes comprises a client application configured to display the video and to communicate with the management component.

13. A method of managing the simultaneous display of a video on two or more nodes within a distributed network, the method comprising:
receiving the video from a first node, and thereafter, transmitting a copy of the video to a second node;
receiving an invitation message from one of the first and second nodes and transmitting the invitation message to the other of the first and second nodes;
receiving an acceptance message responsive to the invitation message; and
after receiving the invitation message and the acceptance message, transmitting playback commands to each of the first and second nodes to control simultaneous display of the video within the first and second nodes.

14. The method of claim 13, wherein the video is captured by an imaging device connected locally to the first node.

15. The method of claim 13, wherein the invitation specifies a date and time for conducting the simultaneous video display.
